(19) United States
(12) Patent Application Publication
(10) Pub. No.: US 2010/0090587 A1
(43) Pub. Date: Apr. 15, 2010

(54) Flat Panel Display

(75) Inventor: Hiroki Tsujimura, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto (JP)

(21) Appl. No.: 11/989,734

(22) PCT Filed: Jul. 26, 2006
(86) PCT No.: PCT/JP2006/314763

§ 371 Date: Jan. 28, 2008

(30) Foreign Application Priority Data
Jul. 29, 2005 (JP) 2005-220245

(51) Int. Cl. H05B 33/04

(52) U.S. Cl. 313/504

(57) ABSTRACT

Provided is a flat panel display (A1), which is for an organic EL display or the like, and is provided with first and second members (1, 3) arranged to face each other to define a hermetically-sealed space (5) surrounding a plurality of display elements (2), and an adhesive (4) for bonding the first and the second members (1, 3) to each other in the periphery of the display elements (2). At least one recessed section (6) to be filled with the adhesive (4) is formed on at least one of the first and the second members (1, 3). At least a part of an inner surface (60) of the recessed section (6) is roughened.

### TECHNICAL FIELD

The present invention relates to flat panel displays, such as an organic EL display, a liquid crystal display, and an FED (field emission display).

### BACKGROUND ART

An organic EL display, for example, is designed in such a manner that a plurality of organic EL elements are provided on one surface of a transparent substrate, and that light emitted from the plurality of organic EL elements passes through the transparent substrate to be emitted to the outside, to thereby display a target image. The organic EL element easily degrades when exposed to oxygen or moisture. If this degradation occurs, the quality of a display image will deteriorate. Specifically, the so-called dark spot, for example, is generated on an image display screen. Then, in the organic EL display, generally, a sealing cover for covering the plurality of organic EL elements is bonded to the transparent substrate so as to protect the organic EL elements.

In the case where the sealing cover is bonded to the transparent substrate, generally, a convex portion is formed in the sealing cover in advance, and then contact portions between a tip of this convex portion and the transparent substrate are bonded to each other using an adhesive. However, with such bonding method, sufficient adhesive strength (adhesion) cannot be obtained. As a consequence, for example, when an external force, such as a thrust force, acts on the sealing cover, this sealing cover may be easily displaced, so that a gap is formed between this sealing cover and the transparent substrate. In such circumstances, the adequate protection of the organic EL elements can not be achieved.

In particular, when the adhesive coated area for the sealing cover and the transparent substrate cannot be taken large due to, for example, the requirement for miniaturization of the whole device, or when impurities exist between the bonding portions due to insufficient cleaning or the like of the transparent substrate, the above-described problem is more likely to occur.

Then, the conventional measures for increasing the adhesive strength of the sealing cover to the transparent substrate includes a measure described in Patent Document 1, for example. In the measure described in this document, a portion in contact with the transparent substrate on the surface of the sealing cover is roughened. With such measure, the contact area between the sealing cover and an adhesive increases as compared with the case where an adhesive is applied to a mere flat portion of the sealing cover. Accordingly, the adhesive strength between the sealing cover and the transparent substrate also increases by just that much.

Patent Document 1: Japanese Unexamined Patent Application Publication No. 2002-260849

### DISCLOSURE OF THE INVENTION

### Problem to be Solved by the Invention

However, since only a flat portion of the sealing cover is roughened, the above-described prior art is yet not sufficient in increasing the adhesive strength between the sealing cover and the transparent substrate, and there is thus room for improvement. In the above-described prior art, in order to obtain sufficient adhesive strength, an adhesive needs to be applied to the sealing cover and the transparent substrate in a wide area. Accordingly, problems may occur in achieving miniaturization or the like of the display as a whole.

The present invention has been made to solve the above-described problem. It is thus an object of the present invention to provide a flat panel display, such as an organic EL display, having a plurality of display elements surrounded by two members bonded to each other. In the flat panel display, the adhesive strength between the two members is sufficiently secured, and the protection of the display elements is adequately achieved while minimizing the coating region of the adhesive as much as possible.

### Means for Solving the Problems

A flat panel display provided by the present invention includes: first and second members arranged to face each other to define a hermetically-sealed space surrounding a plurality of display elements; and an adhesive for bonding the first and the second members to each other in the periphery of the display elements. In this flat panel display, one or a plurality of recessed sections to be filled with the adhesive are formed on at least one of the first and the second members, and at least a part of an inner surface of the recessed section is roughened.

According to such a configuration, a recessed section is formed on at least one of the first and the second members, and an inner surface of the recessed section is roughened. Accordingly, the substantial area of the roughened portion on the inner surface of the recessed section can be taken large even if the apparent area (area in a surface view of the recessed section) of the recessed section is reduced, for example, by reducing the width of the recessed section.

More specifically, in the case where the recessed section is formed, for example, in a cross-sectional rectangular shape, in addition to a bottom face of this recessed section, two side faces erecting from the bottom face can be also roughened. Consequently, the area of roughened portions becomes quite large. Then, when the area of a portion that is roughened in this manner becomes large, the adhesion of the adhesive also can be increased by just that much. Accordingly, the adhesive strength between the first and second members also increases. As a result, even if the first and second members receive, for example, an external force or the like, these members are suppressed from being easily displaced to form a gap therebetween. Accordingly, the display elements are protected adequately. On the other hand, according to the present invention, since the apparent coated area of the adhesive is reduced, there is no need to secure a region with a large area for applying the adhesive to the first and second members. Accordingly, the present invention is also suitable in achieving the miniaturization or the like of the display as a whole.

In a preferred embodiment of the present invention, the each display element is an organic EL element, and the first and second members are a substrate, on which the above-described organic EL element is formed, and a sealing cover bonded to this substrate, and these are configured as an organic EL display.

Accordingly, the flat panel display concerning the present invention is suitably configured as an organic EL display. However, the present invention, of course, may be configured as flat panel displays other than the organic EL display as described later.

In another preferred embodiment of the present invention, the recessed section to be filled with the adhesive is provided as a rectangular or non-rectangular annular groove surrounding the entire circumference of an outer perimeter of the plurality of organic EL elements in the sealing cover. In addition, the substantially entire surface of the inner surface of the recessed section is roughened.

According to such a configuration, adhesion between the substrate and the sealing cover is secured at the entire circumference of the plurality of organic EL elements, and the airtightness of a hermetically-sealed space by which the plurality of organic EL elements are surrounded is improved. Thereby, inflow of moisture and air to this hermetically-sealed space is surely prevented.

In yet another preferred embodiment of the present invention, a recessed section to be filled with the adhesive is formed also in the substrate, and this recessed section is formed in a portion other than a wiring forming portion on the substrate where a wiring section extends outwardly from the plurality of organic EL elements.

According to such a configuration, the recessed section whose inner surface is roughened is also formed in the substrate in addition to in the sealing cover. Thereby, the adhesive strength between these sealing cover and substrate can be increased further. Moreover, in the substrate, the recessed section is not formed in a portion where the wiring section for the plurality of organic EL elements is formed, to thereby make the portion a flat surface. Accordingly, the above-described wiring section is formed appropriately.

### EFFECT OF THE INVENTION

According to the flat panel display of the present invention, a recessed section is formed on at least one of the first and the second members that are arranged to face each other to define a hermetically-sealed space surrounding a plurality of display elements, and an inner surface of the recessed section is roughened. Accordingly, even if the apparent area of the recessed section is reduced by reducing the width of the recessed section, the substantial area of the roughened portion on the inner surface of the recessed section can be taken large. As a result, the adhesive strength is increased.

Moreover, when a recessed section, in which the substantially entire surface of the inner surface is roughened, is provided as a rectangular or non-rectangular annular groove surrounding the entire circumference of an outer perimeter of a plurality of organic EL elements in the sealing cover, the airtightness of a hermetically-sealed space, by which a plurality of organic EL elements are surrounded, is improved.

Moreover, a recessed section whose inner surface is roughened is also formed in the substrate in addition to in the sealing cover, and thereby the adhesive strength between the sealing cover and the substrate can be increased further. Furthermore, the recessed section is not formed in a portion where the wiring section is formed, to thereby make the portion a flat surface. As a result, the above-described wiring section is formed appropriately.

### BRIEF DESCRIPTION OF THE DRAWINGS

FIG. 1 is a partially cutaway perspective view showing an example of an organic EL display employing the present invention.

FIG. 2 shows a IIa-IIa cross sectional view of FIG. 1, and an enlarged view of a IIb portion in FIG. 2 (a).

FIG. 3 is a perspective view on a rear surface side of a sealing cover used in the organic EL display shown in FIG. 1 and FIG. 2.

FIG. 4 is a cross sectional view showing another example of an organic EL display employing the present invention.

FIG. 5 is a perspective view showing a configuration, in which a recessed section is formed in a transparent substrate of the organic EL display shown in FIG. 4.

FIG. 6 is a cross sectional view showing yet another example of an organic EL display employing the present invention.

FIG. 7 is a perspective view showing an example, in which a plurality of recessed sections are formed in a sealing cover, according to the present invention.

FIG. 8 shows cross sectional views of a substantial part showing other examples of cross-sectional shape of a recessed section formed, according to the present invention.

### DESCRIPTION OF REFERENCE NUMERALS

A1-A3 organic EL display (flat panel display)
1 transparent substrate (first member)
2 organic EL element (display element)
3 sealing cover (second member)
4 adhesive
5 hermetically-sealed space
6, 6A recessed section
60 inner surface (of recessed section)

### BEST MODE FOR CARRYING OUT THE INVENTION

Hereinafter, preferred embodiments of the present invention will be specifically described with reference to the accompanying drawings.

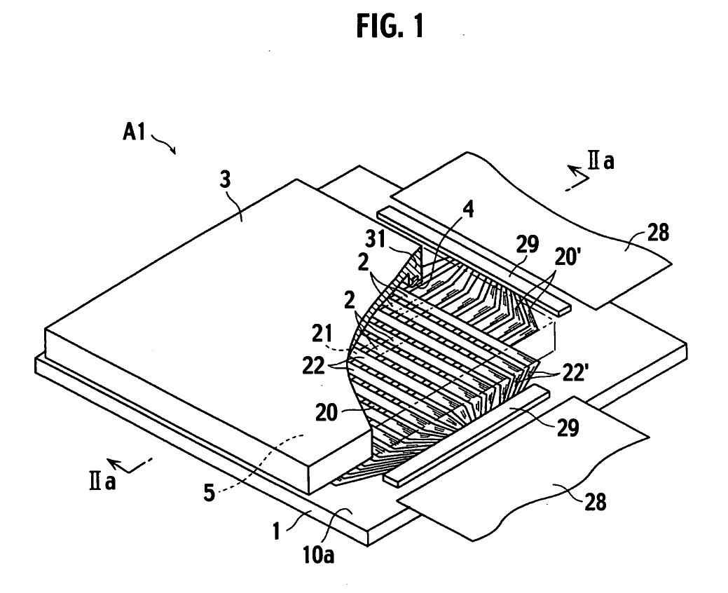

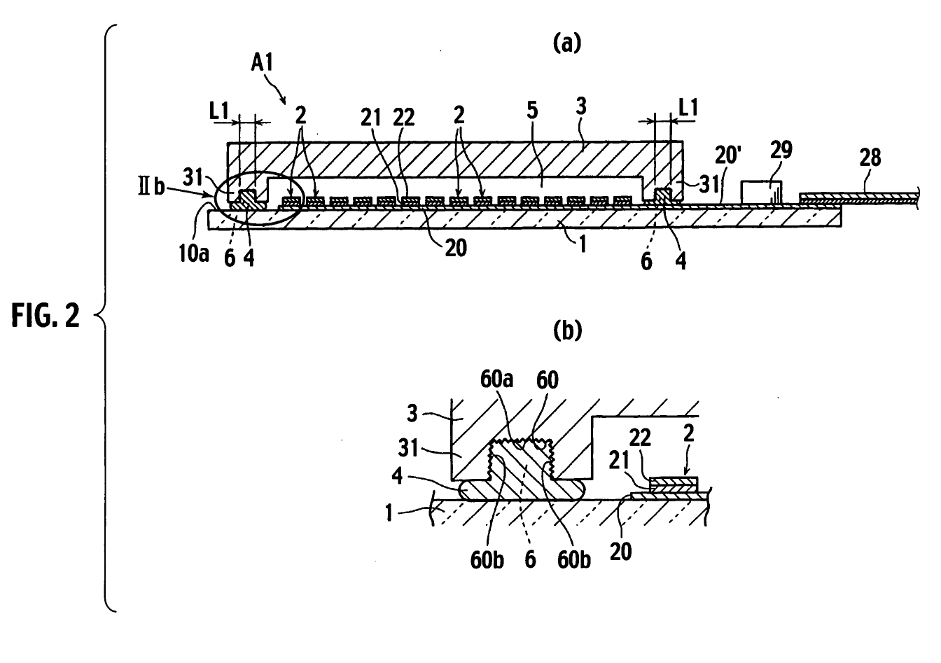

FIG. 1 and FIG. 2 show an organic EL display employing present invention. FIG. 2 (a) shows a IIa-IIa cross sectional view of FIG. 1, and FIG. 2 (b) shows an enlarged view of a IIb portion in FIG. 2 (a). An organic EL display A1 of this embodiment includes a transparent substrate 1, a plurality of organic EL elements 2, a sealing cover 3, and an adhesive 4 for bonding the sealing cover 3 to the transparent substrate 1. Light generated in each organic EL element 2 passes through the transparent substrate 1 downwardly and exits therefrom, and thereby a target image is displayed.

The transparent substrate 1 corresponds to a base member for forming a plurality of organic EL elements 2. The transparent substrate 1 is rectangular tabular, for example, and is made of a transparent resin or made of glass. The plurality of organic EL elements 2 selectively emit light upon application of an electric field, and are arranged in a matrix form. Each organic EL element 2 may have a conventionally known configuration. For example, each organic EL element 2 may be fabricated by forming, in a predetermined pattern, a plurality of transparent anodes 20, an organic layer 21, and a plurality of cathodes 22 and by laminating them in this order on an upper surface 10a of the transparent substrate 1.

In the illustrated example, each organic EL element 2 has a configuration in which the organic layer 21 is interposed at the crossing portions of a plurality of strip-shaped anodes 20 extending vertically and horizontally and cathodes 22. The on/off drive of the organic EL elements 2 is controlled by a driver IC 29 connected to wiring sections 20′ and 22′ of the anodes 20 and cathodes 22. Signals for image display are sent to the driver IC 29 from the outside via a flat cable 28, for example. In addition, each anode 20 is formed of, for example, ITO. Each organic layer 21 includes a luminous layer (illustration is omitted) containing a light-emitting material which self-emits light upon application of an electric field. Each cathode 22 is formed of a metal with high optical reflectivity, for example, such as aluminum, that can reflect light generated in the organic layer 21 toward the transparent substrate 1 side.

The sealing cover 3 is made of a resin or made of glass, for example. The sealing cover 3 is overlaid and bonded onto the transparent substrate 1, thereby forming, together with this transparent substrate 1, a hermetically-sealed space 5 for sealing the plurality of organic EL elements 2. The entire shape of this sealing cover 3 is, for example, substantially rectangular tabular. At the outer edge of the sealing cover 3, a downwardly-facing convex portion 31 is formed. This convex portion 31 is a portion which is arranged so as to surround the organic EL element 2 forming region when the sealing cover 3 is bonded to the transparent substrate 1. The convex portion 31 is used for bonding the sealing cover 3 to the transparent substrate 1.

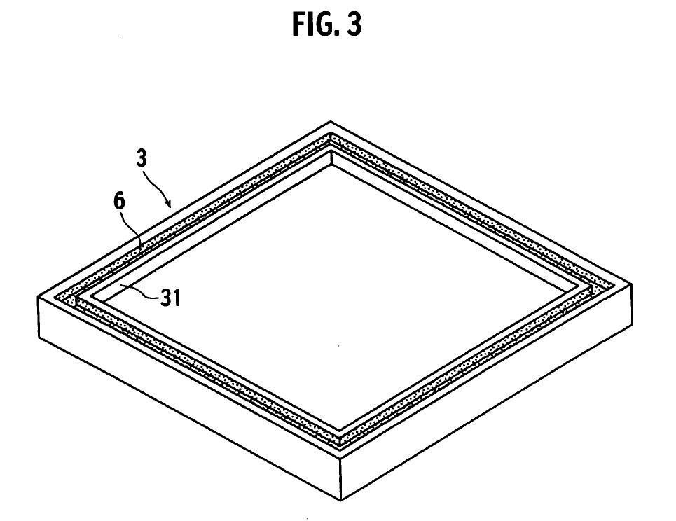

In the convex portion 31 of the sealing cover 3, on an end face to be bonded to the transparent substrate 1 is formed a recessed section 6 to be filled with the adhesive 4. This recessed section 6 has a groove shape with a rectangular-annular narrow width as shown in FIG. 3. As shown in the substantial part enlarged view of FIG. 2, this recessed section 6 has a cross-sectional rectangular shape. The recessed section 6 has, as its inner surface 60, a bottom face 60a (which, however, is a ceiling face in the view) and a pair of side faces 60b connected to this bottom face 60a. These bottom face 60a and pair of side faces 60b as a whole are roughened for the purpose of increasing the adhesion to the adhesive 4. The degree of surface roughening is, for example, 1 μm to 10 μm in center line average roughness.

As the measure for achieving such surface roughening, for example, blasting such as sandblasting, or etching processing may be used. In these processing, if blasting or etching processing is carried out to perform surface roughening processing to the bottom face 60a of the recessed section 6, this processing also reaches the pair of side faces 60b (abrasive or etchant acts also on the side faces 60b). Accordingly, in addition to the bottom face 60a, the pair of side faces 60b is also subjected to the surface roughening process. Note that the recessed section 6 can be formed in molding the sealing cover 3 using a die, for example.

The adhesive 4 is ultraviolet curable, for example, and is filled inside the recessed section 6 so as to bond the sealing cover 3 to the transparent substrate 1. The sealing cover 3 and the transparent substrate 1 are boded to each other in such a manner that the rectangular annular recessed section 6 and the adhesive 4 surround the outer periphery of the organic EL element 2 forming region.

Next, an effect of the organic EL display A1 is described.

Firstly, while the adhesive 4 is filled inside the recessed section 6 formed in the sealing cover 3, the entire inner surface 60 of this recessed section 6 is roughened. Accordingly, even if a width L1 of this recessed section 6 is made relatively thin, the substantial contact area between the inner surface 60 of this recessed section 6 and the adhesive 4 becomes quite large. Consequently, the adhesive 4 is strongly adhered to the sealing cover 3, resulting in an increase in the adhesive strength and adhesion between this sealing cover 3 and the transparent substrate 1.

For example, even if a certain external force acts on the sealing cover 3, it is possible to prevent the sealing cover 3 from being easily displaced. Accordingly, it is possible to prevent formation of a gap which allows air to pass the displaced portion, to which the adhesive 4 is applied. In particular, the recessed section 6 is excellent in retaining the airtightness of the hermetically-sealed space 5 because the recessed section 6 is rectangular annular and surrounds the entire circumference of the plurality of organic EL elements 2.

Consequently, the deterioration of display image quality due to early degradation of the plurality of organic EL elements 2 under the influence of oxygen or moisture is suppressed appropriately. Moreover, in this organic EL display A1, the adhesive strength is increased as described above even if the width L1 of the recessed section 6 is made relatively narrow. Accordingly, there is no need to secure a wide region as the coating region for the adhesive 4 in the sealing cover 3 and the transparent substrate 1. As a result, miniaturization of the entire organic EL display A1 is also achieved by just that much.

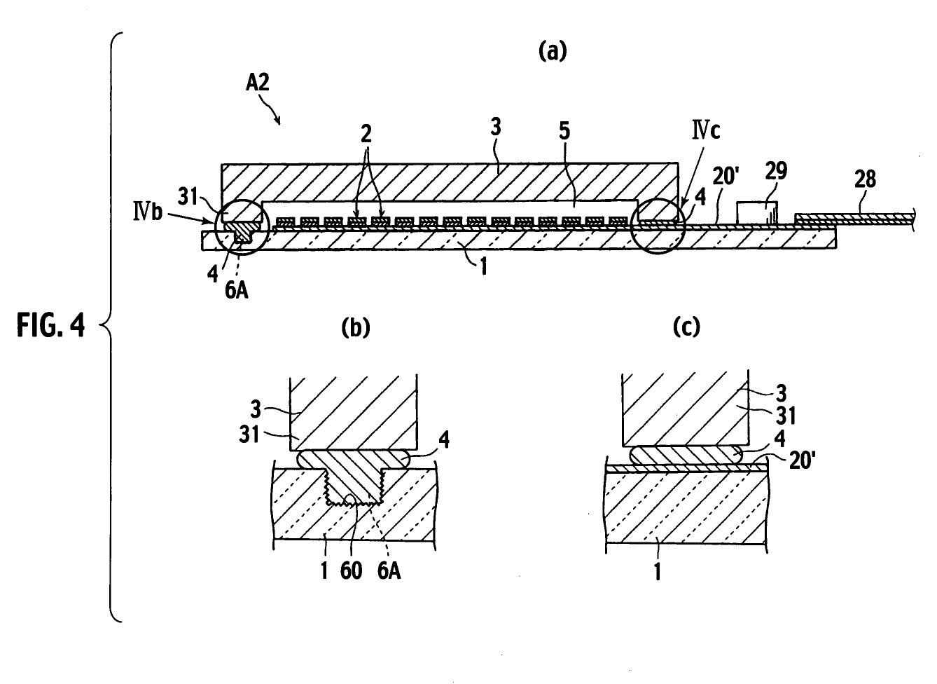

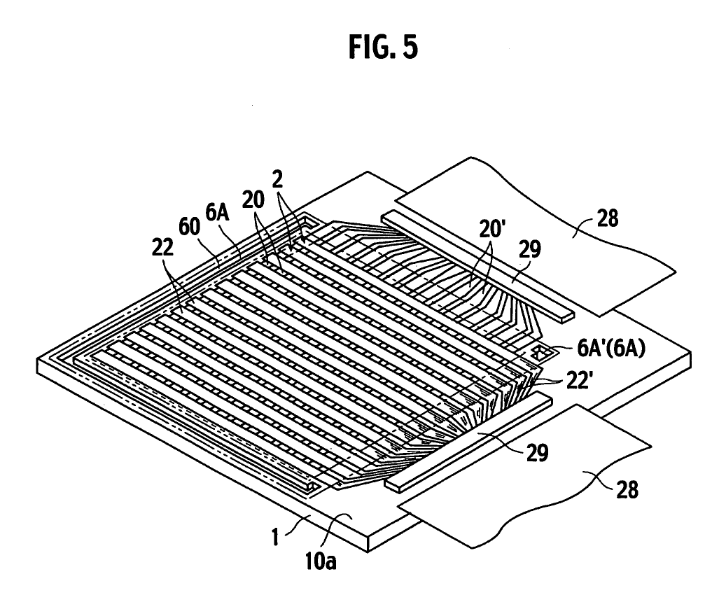

FIG. 4 and FIG. 5 show other examples of an organic EL display employing the present invention. Note that, in FIG. 4 and the following drawings, an element identical or similar to that of the above-described embodiment is given the same reference numeral as that of the above-described embodiment. FIG. 4 shows a cross sectional view of FIG. 5 (the same direction as the IIa-IIa direction of FIG. 1). Moreover, FIG. 4 (b) shows an enlarged view of a IVb portion of FIG. 4 (a), and FIG. 4 (c) shows an enlarged view of a IVc portion of FIG. 4 (a).

An organic EL display A2 shown in FIG. 4 is designed in such a manner that a recessed section 6A to be filled with the adhesive 4 is formed in the transparent substrate 1, while the recessed section is not provided in the sealing cover 3. As shown well in FIG. 5, the recessed section 6A is provided in portions other than the circumference of the organic EL element 2 forming region, where wiring sections 20′ and 22′ of a plurality of anodes 20 and cathodes 22 are formed. The recessed section 6A is formed as a substantially L-shaped groove in a plan view, for example. In a gap portion where the wiring sections 20′ and 22′ lie against each other, a relatively short recessed section 6A′ (6A) is separately formed. The surface roughening processing is performed on the entire inner surface of these recessed sections 6A as in the case of the above-described inner surface of the recessed section 6.

In the organic EL display A2 of this embodiment, bonding of the transparent substrate 1 to the sealing cover 3 is achieved via the adhesive 4 filled in the recessed section 6A. Of course, bonding to the sealing cover 3 is achieved by applying the adhesive 4 also to portions in the circumference of the organic EL element 2 forming region, where the recessed section 6A is not formed (that is, for example, the wiring section 20′ and 22′ forming portions). Also in this embodiment, since the entire inner surface 60 of the recessed section 6A is roughened, the substantial contact area between this inner surface 60 and the adhesive 4 is large.

Accordingly, as in the above-described embodiment, the adhesive strength between the transparent substrate 1 and the sealing cover 3 is secured to increase the adhesion thereof. Consequently, protection of the plurality of organic EL elements 2 is appropriately achieved. Moreover, the coating width (i.e., width of the recessed section 6A) of the adhesive 4 can be narrowed, and there is no need to secure the coating region with a large area for the adhesive 4 on the transparent substrate 1. Furthermore, in forming portions of the wiring sections 20′ and 22′ on the surface of the transparent substrate 1, the recessed section is not formed and the surfaces of these portions are flat. For this reason, the pattern formation of the wiring sections 20′ and 22′ onto the transparent substrate 1 is performed appropriately.

In addition, the wiring section that is routed outward from the plurality of organic EL elements in the organic EL display can be formed in various patterns. Accordingly, in the case where the recessed section is formed in the transparent substrate as in this embodiment, the shape, arrangement, number, and the like of the recessed section may be suitably selected corresponding to the specific pattern of such wiring section.

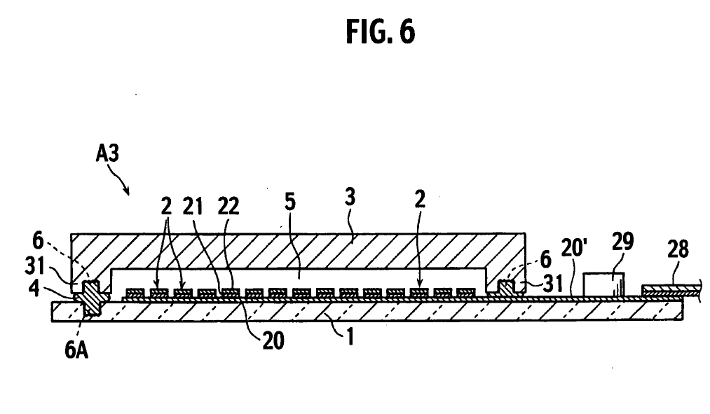

In an organic EL display A3 shown in FIG. 6, while the recessed section 6 is formed in the sealing cover 3, a recessed section 6A is formed also in the transparent substrate 1. These recessed sections 6, 6A face each other, and the interiors thereof are filled with the adhesive 4. The recessed sections 6, 6A have the same configuration as that of the above-described embodiments. According to this embodiment, the adhesive strength between the transparent substrate 1 and the sealing cover 3 can be further improved. As a result, further secure protection of the organic EL element 2 is achieved by preventing the displacement and the like of the sealing cover 3 while reducing the apparent area for applying the adhesive 4.

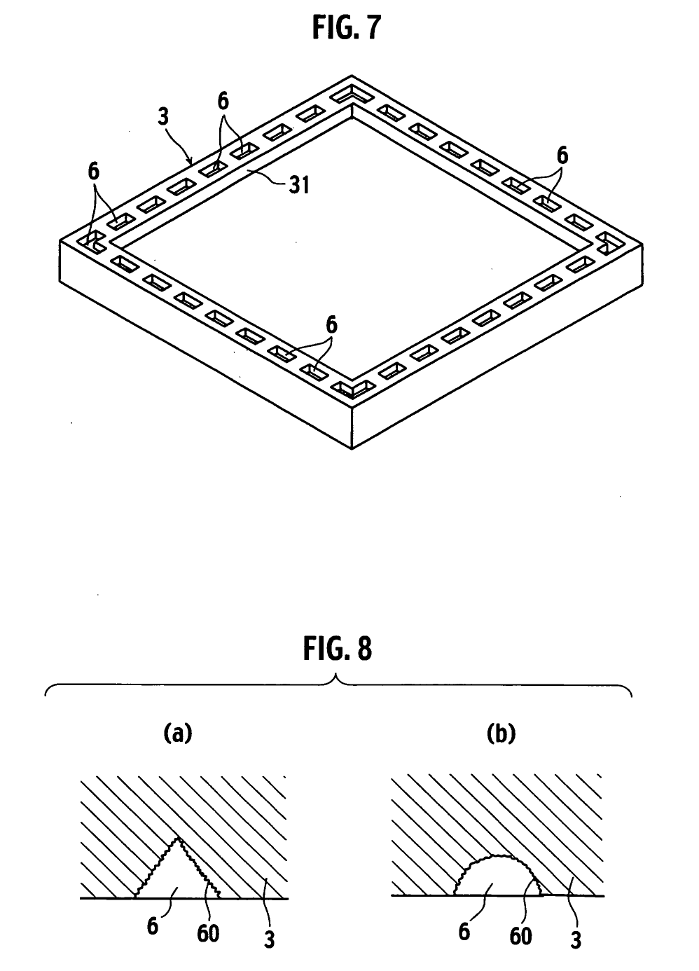

In an embodiment shown in FIG. 7, a plurality of recessed sections 6 whose inner surface is roughened are discretely formed in the sealing cover 3. Even with such a configuration, an effect of increasing the adhesive strength to the adhesive is obtained, and the intended object of the present invention is achieved. As seen from this embodiment, in the present invention, the recessed section to be filled with an adhesive may be daringly formed in a discontinuous shape.

In embodiments shown in FIG. 8 (a), (b), the cross-sectional shape of the recessed section 6 is formed in a triangle or semicircle shape. Even with such configurations, the object of the present invention is achieved by roughening the inner surface 60. Thus, in the present invention, the cross-sectional shape of the recessed section is not limited, either.

The present invention is not limited to the above-described embodiments. Specific configurations of each part of the flat panel display concerning the present invention may be designed in various ways.

In the present invention, the substantially entire inner surface of a recessed section to be filled with an adhesive is preferably roughened. However, the invention is of course not limited to this configuration. The cases where a part of the inner surface is roughened is also included in the technical scope of the present invention. The adhesives other than the ultraviolet curable one can be also used.

Although examples, in which the present invention is employed in an organic EL display, have been described in the above-described embodiments, the present invention can be also employed in other flat panel displays, such as a liquid crystal display and an FED. Accordingly, as for the first and second members referred to in the present invention, members different from the combination of a substrate and a sealing cover can be used. Also, as for the display element referred to in the present invention, elements different from the organic EL element can be used. In addition, a flat panel display can be used not only as a simple image display, but also, for example, as an exposure device for selectively exposing a certain area of a light sensitive paper in an exposure type printer (that is, print head used for exposure). Those used in such application are also included in the flat panel display referred to in the present invention.

1. A flat panel display, comprising:
first and second members arranged to face each other to define a hermetically-sealed space surrounding a plurality of display elements; and
an adhesive for bonding the first and the second members to each other in the periphery of the display elements, characterized in that
at least one recessed section to be filled with the adhesive is formed on at least one of the first and the second members, and at least a part of the inner surface of each recessed section is roughened.

2. The flat panel display according to claim 1, which is configured as an organic EL display, wherein
each display element is an organic EL element, and the first and second members are a substrate in which the organic EL elements are formed, and a sealing cover bonded to this substrate.

3. The flat panel display according to claim 2, wherein the recessed section to be filled with the adhesive is provided in the sealing cover to be an annular groove having any one of a rectangular and a non-rectangular profile and surrounding the entire circumference of an outer perimeter of the plurality of organic EL elements, and the substantially entire surface of the inner surface of the recessed section is roughened.

4. The flat panel display according to claim 3, wherein a recessed section to be filled with the adhesive substrate is formed also in the substrate, and this recessed section is formed in a portion other than a wiring forming portion where a wiring section extends outwardly from the plurality of organic EL elements on the substrate.
